(19) United States
(12) Patent Application Publication
(10) Pub. No.: US 2006/0072081 A1
(43) Pub. Date: Apr. 6, 2006

(54) Combination structure for projection device

(75) Inventors: Yi-Hsiung Peng, Miao-Li (TW); Wen-Min Huang, Miao-Li (TW); Wen-Panz Tsai, Miao-Li (TW); Jung-Chi Chen, Miao-Li (TW); Tsan-Fu Tseng, Miao-Li (TW)

Correspondence Address: BACON & THOMAS, PLLC, 625 SLATERS LANE, FOURTH FLOOR, ALEXANDRIA, VA, 22314, US

(73) Assignee: Coretronic Corporation, Miao-Li (TW)

(21) Appl. No.: 11/227,222

(22) Filed: Sep. 16, 2005

(30) Foreign Application Priority Data
Oct. 1, 2004 (TW) 093130051

(51) Int. Cl. G03B 21/22

(52) U.S. Cl. 353/119

(57) ABSTRACT

A projection device comprises a plurality of elements, a base seat and an outer cover. The elements are used for respectively executing specific functions to cause the projection device to operate. The base seat comprises a first side surface and a second side surface, an element fixing structure is disposed on the first side surface and used for fixing the elements, and a first fixing device is disposed on the second side surface. The outer cover comprises a third side surface and a fourth side surface, the third side surface is used for forming an outlook surface and a second fixing device is disposed on the fourth side surface. The elements are installed on the element fixing structure, the first fixing device and the second fixing device are combined together when the projection device is assembled.

### BACKGROUND OF THE INVENTION

1. Field of the Invention

The present invention relates to a projection device, and more particularly to a combination structure for combining a plurality of internal elements with an outer cover in the projection device.

2. Description of Related Art

Please refer to FIG. 1 and FIG. 2. A conventional projector 10 comprises a plurality of internal elements 12 for allowing the projector 10 to operate, a lower cover 14 and an upper cover (not shown in the figure). An element connection module 16 is disposed on an upper side surface of the lower cover 14 for directly fixing the internal elements 12 on the upper side surface of the lower cover 14. A lower side surface of the lower cover 14 is an outlook surface of the projector 10. When the projector 10 is to be assembled, the internal elements 12 are first fixed on the upper side surface of the lower cover 14 and the upper cover is then combined with the lower cover 14 so as to form a complete housing (not shown in the figure) to cover the internal elements 12 therein.

A series of assembly and test procedures must be processed before the conventional projector 10 is sold to a user. Among these procedures, if scrapes or bad structure precisions appear on the lower cover 14, the lower cover 14 must be reassembled to prevent a flawed production from being sold. Because the internal elements 12 are fixed on the lower cover 14, they must be respectively detached from the lower cover 14 one by one and then reinstalled onto a new lower cover. This causes the time consuming. Besides the lower cover 14 must have both an artistic outlook and the precise element connection module 16, the production cost thereof is not cheap. If the replacement must be made only because the outlook of the lower cover 14 is defected, the production cost of the projector 10 will be increased.

### SUMMARY OF THE INVENTION

One object of the present invention is to provide a projection device for solving the problem caused from the conventional projector mentioned above.

The projection device comprises a plurality of elements, a base seat and an outer cover. The elements are respectively used to execute specific functions to cause the projection device to operate. The base seat comprises a first side surface and a second side surface. An element fixing structure is disposed on the first side surface for fixing the elements and a first fixing device is disposed on the second side surface. The outer cover comprises a third side surface and a fourth side surface. The third side surface is used for forming an outlook surface of the projection device and a second fixing device is disposed on the fourth side surface. When the projection device is being assembled, the elements are installed on the element fixing structure of the base seat, and the first fixing device of the base seat is combined with the second fixing device of the outer cover.

As mentioned above, the elements are first fixed on the base seat to form a projection module. And then, the base seat of the projection module is combined with the outer cover to form the projection device of the present invention. When The outer cover needs to be replaced as a result of defects (e.g. scrape and bad size precision) appearing on the outer cover, the replacement thereof can then be processed after the projection module is detached from the outer cover. Such kind of course of action saves time and replaces easily. Furthermore, the outer cover according to the present invention only has an outlook function and the simple fixing device so that the manufacturing is easy and the production cost is low. Besides, only the projection module needs to be tested when the test of the projection device is to be processed and the outer cover is assembled after the test is completed so that any damage of the outer cover can be avoided while testing. And, the projection module is suitable for use in the projection device with different outlooks to enhance the applicable-to-all property.

### BRIEF DESCRIPTION OF THE DRAWINGS

The present invention can be more fully understood by reference to the following description and accompanying drawings, in which:

FIG. 1 is a schematic view of a conventional projector;

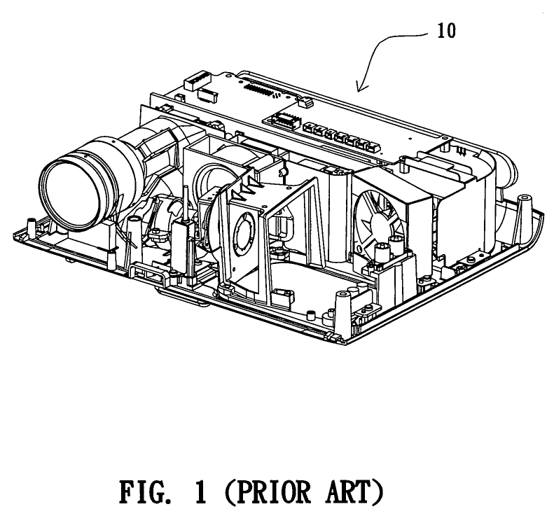

FIG. 2 is an explosive view showing a plurality of internal elements assembled on a lower cover in a conventional projector;

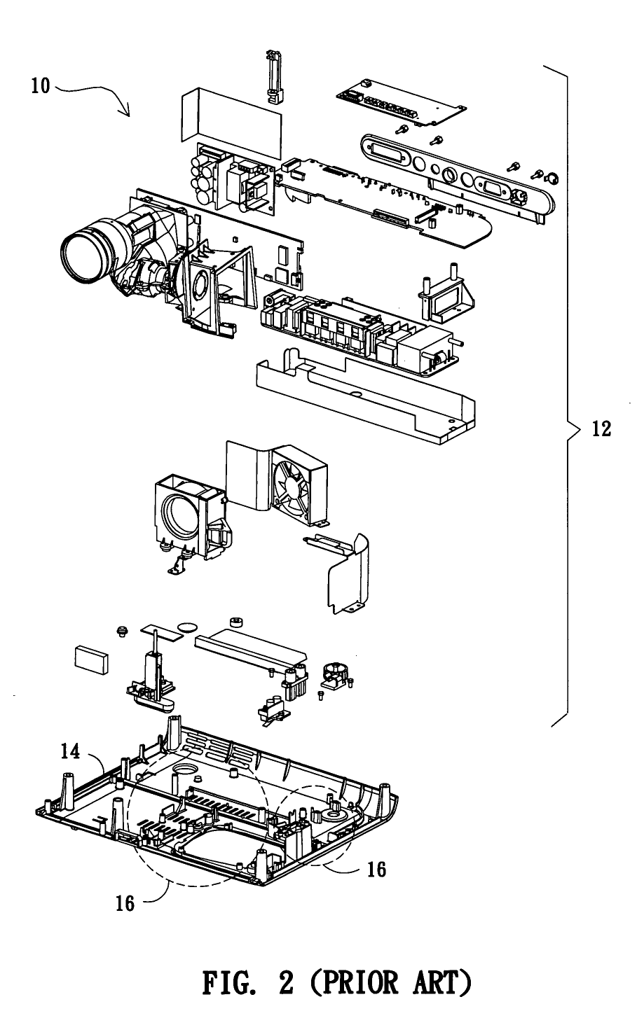

FIG. 3 is an explosive view showing an assembly of a plurality of elements and a base seat in a projection device according to the present invention; and

FIG. 4 is an explosive view showing a combination of a projection module and a lower cover according to the present invention.

### DETAILED DESCRIPTION OF THE PREFERRED EMBODIMENTS

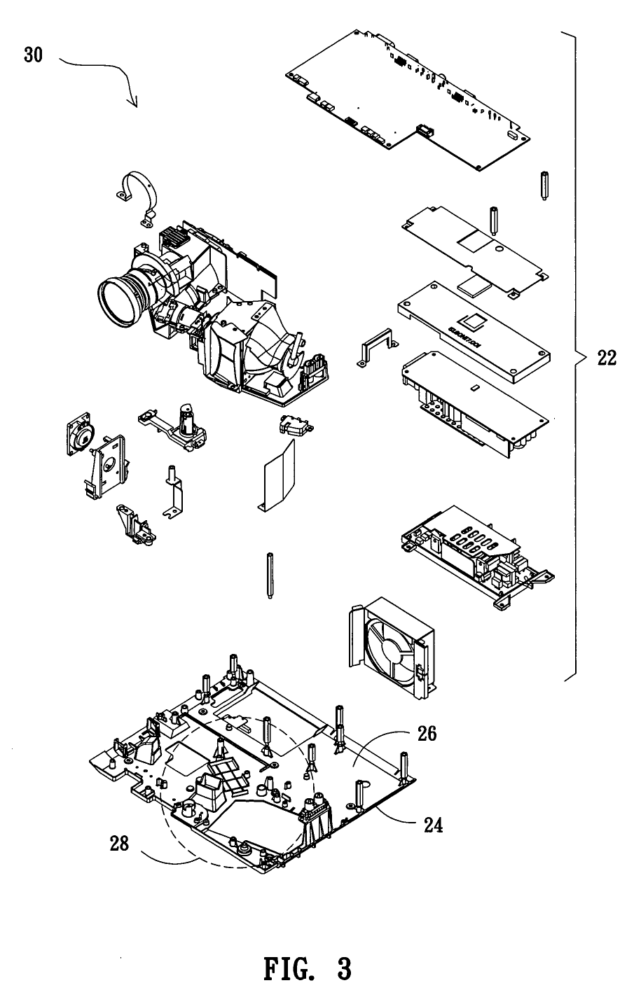

Please refer to FIG. 3. FIG. 3 is an explosive view showing an assembly of a plurality of elements 22 and a base seat 24 in a projection device 20 according to the present invention. The projection device 20 comprises the elements 22 and the base seat 24. The elements 22 respectively execute specific functions to cause the projection device to operate and further to project images. For example, the elements 22 are basic parts of the projection device such as an optical engine, a fan, and a light bulb. The shape of the base seat 24 is close to a plain plate. The base seat 24 is made from metal materials to allow it to be easy in heat dissipation and manufacturing. The base seat 24 comprises a first side surface 26 and a second side surface (not shown in the figure), the first side surface 26 and the second side surface are face to face. The first side surface 26 is an upper side surface of the base seat 24, an element fixing structure 28 is disposed on the first side surface 26. The element fixing structure 28 is disposed corresponding to the positions of the elements 22 for fixing the elements 22. Whereby, the elements 22 and the base seat 24 are constructed a projection module 30. The second side surface is a lower side surface of the base seat 24, a first fixing device is a plurality of screw holes (not shown in the figure).

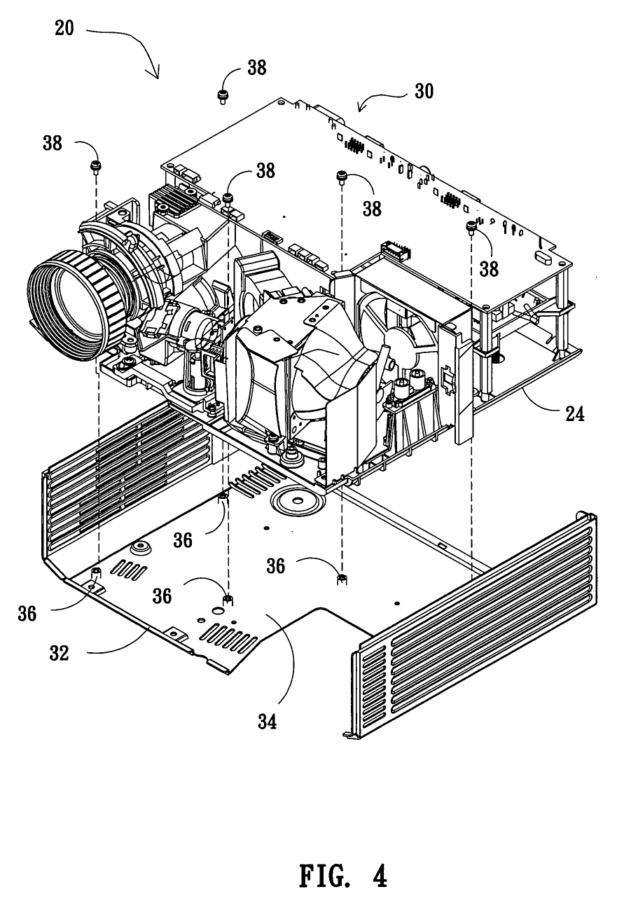

Please refer to FIG. 4. The projection device 20 according to the present invention further comprises an outer cover 32 used for forming an outlook surface of the projection device 20. In this preferred embodiment, the outer cover 32 is a lower cover of the projection device 20. The outer cover 32 comprises a third side surface (not shown in the figure) and a fourth side surface 34, and the third side surface and the fourth side surface 34 are face to face. The third side surface is used for forming the outlook surface of the projection device 20 and the fourth side surface 34 is an upper side surface of the outer cover 32. A second fixing device is disposed on the fourth side surface 34. The second fixing device is a plurality of screw bolts 36, the screw bolts 36 are disposed corresponding to the positions of the screw holes (not shown in the figure). When the projection module 30 and the outer cover 32 are combined together, a plurality of screws 38 is used to respectively pass through the screw holes and respectively screwed into the screw bolts 36 to complete the combination.

In another preferred embodiment, the combination way of the first fixing device of the base seat 24 and the second fixing device of the outer cover 32 is not limited to locking together through the screws 38, locking together through hooking device or other mechanical combination manner can also be applied. Furthermore, the material of the base seat 24 is not limited to metal materials, plastic materials can also be adopted.

Comparing to the conventional technology, according to the present invention, the elements 22 are first fixed onto the base seat 24 to form the projection module 30, and the base seat 24 of the projection module 30 and the outer cover 32 are then combined to each other, the whole construction is applied to the projection device 20. When the outer cover 32 needs to be replaced as a result of defects (e.g. scrape and bad size precision) appearing on the outer cover 32, the replacement thereof can then be processed after the projection module 30 is detached from the outer cover 32. It is unnecessary to be processed like the conventional technology that the internal elements 12 must first respectively detached from the lower cover 14 one by one and then installed respectively onto a new lower cover. This will cause the waste on the production time. According to the present invention, the outer cover 32 only has an outlook function and simple fixing device. The effects of the present invention are the less production time, the easy replacement, the easy manufacturing, and the low production cost. Besides, when the test of the production device is to be processed, only the projection module 30 needs to be tested, and the outer cover 32 is then installed thereon after the test is complete so that any damage on the outer cover 32 can be avoided while testing. The elements (e.g. an optical engine, a fan and a light bulb) for projecting images are formed to be a projection module 30 to separate from an outlook element (e.g. the outer cover 32) so that the projection module 30 is matched with the projection device with different outlooks to use, the applicable-to-all property is enhanced.

It is noted that the combination structure for the projection device described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A projection device, comprising:
a plurality of elements, used for respectively executing specific functions to cause said projection device to operate;
a base seat, comprising a first side surface and a second side surface, said first side surface and said second side surface being face to face, an element fixing structure being disposed on said first side surface and used for fixing said elements, and a first fixing device being disposed on said second side surface; and
an outer cover, comprising a third side surface and a fourth side surface, said third side surface and said fourth side surface being face to face, said third side surface being used for forming an outlook surface of said projection device, and a second fixing device being disposed on said fourth side surface;
wherein said elements are installed on said element fixing structure of said base seat, and said first fixing device of said base seat and said second fixing device of said outer cover are combined together when said projection device is assembled.

2. The projection device according to claim 1, wherein said first fixing device of said base seat and said second fixing device of said outer cover are combined together through screws.

3. The projection device according to claim 1, wherein said first fixing device of said base seat and said second fixing device of said outer cover are fixed together by means of a hooking device.

4. The projection device according to claim 1, wherein said base seat is made from metal materials.

5. The projection device according to claim 1, wherein said outer cover is a lower cover of said projection device.

6. The projection device according to claim 1, wherein said base seat comprises a plain plate.
